(19) United States
(12) Patent Application Publication
(10) Pub. No.: US 2015/0080237 A1
(43) Pub. Date: Mar. 19, 2015

(54) PIPELINE FOR RATIONAL DESIGN AND INTERPRETATION OF BIOMARKER PANELS

(71) Applicant: University of Connecticut, Farmington, CT (US)

(72) Inventors: Craig E. Nelson, Mansfield, CT (US); Ion Mandoiu, Storrs, CT (US); Hector Leonardo Aguila, West Hartford, CT (US)

(21) Appl. No.: 14/395,336

(22) PCT Filed: Apr. 19, 2013
(86) PCT No.: PCT/US13/37410

§ 371 Date: Oct. 17, 2014

Related U.S. Application Data
(60) Provisional application No. 61/636,225, filed on Apr. 20, 2012.

(51) Int. Cl. G06F 19/24; G06F 19/28; C40B 30/02

(52) U.S. Cl. CPC G06F 19/24; C40B 30/02; G06F 19/28
USPC 506/8; 702/19

(57) ABSTRACT

A new pipeline for the rational design and interpretation of biomarker panels is provided. The pipeline includes: generating the maximally informative marker set from biomarker databases; selecting an optimal biomarker panel based on the desired accuracy, economic, and experimental constraints; and interpreting the assay results by a statistically robust matching to reference data. The pipeline can also be used to identify biological samples, including cell types and progenitor cells.

### BACKGROUND OF THE DISCLOSURE

1. Field of Disclosure

A new pipeline for the rational design and interpretation of biomarker panels from underlying biological databases is disclosed. The pipeline is a series of steps that include generating the maximally-informative biomarker set, selecting an optimal panel size balancing the desired levels of accuracy, economy and throughput, and interpreting results using a statistically robust matching of results from user assays to reference data. The pipeline can be used to identify a particular type of cell(s) present in a sample, such as a type of disease cell or progenitor cell.

2. Description of Related Art

A biomarker is a small molecule, often an RNA or a protein molecule, that is differentially expressed in a specific cell type, allowing that molecule to be used as a distinguishing signal (i.e., marker) to identify the source as a particular cell type. Another example of a biomarker is a DNA sequence, which can be a genetic biomarker of a cell that causes disease or is associated with susceptibility to disease. While biomarkers generally can be used to help distinguish one cell type from another, a single RNA or protein biomarker may be present in several different types of cells, and so the presence (or absence) of a single biomarker in a cell sample is often not sufficient to conclusively identify the cell type or distinguish one cell type from another in a mixed sample. Accurate identification of cell types by using biomarkers often requires identifying a profile of several biomarkers (i.e., their presence, absence, and/or amount) in order to identify, with a high degree of confidence in the results, the cell type(s) in the sample.

Biomarker panels are increasingly important clinical tools for the classification of tissue samples and, more recently, have been used to characterize differentiating stem cell cultures. To facilitate high sample throughput, biomarker panels are often limited to a finite number of hand-picked genes deemed to be of significance by the researcher. However, the selection of biomarkers, and how many of them to use, are often made on an ad hoc basis. Without statistical support that the most-informative biomarkers have been selected, biomarker panels can be subject to extensive sampling bias that can result in misclassification and wasted resources. Moreover, the accurate mapping of marker profiles to discrete classes is not always straightforward.

While individual biomarkers are not able to exclusively distinguish one cell type from the other, a combination of biomarkers can, or is more likely to, correctly identify a cell type. However, the process of obtaining, testing and validating these biomarkers to distinguish between cell types by conventional approaches is inaccurate as well as expensive.

### SUMMARY OF THE DISCLOSURE

The present disclosure provides a pipeline for rational design and interpretation of biomarker panels to accurately and efficiently identify an unknown biological sample, and to distinguish among cell types therein. More specifically, the pipeline includes sequence of steps that include: generating the maximally-informative marker set from a biomarker database; determining a tailored size of the biomarker panel based on the end user's need for accuracy, cost, volume and speed; and matching the results from user assays as compared with reference data or samples to provide a statistically robust interpretation of the biomarker assay.

The output of the pipeline, therefore, is an accurate assessment of the probable identity of an unknown cell type (or types) in a sample, along with a numerical value of the degree of certainty about the identification, which can be expressed as a probability.

The pipeline of the present disclosure also provides a tool to determine (by use of the probabilities) that, in a “mixed” sample having multiple unknown cell types, there are a certain number of different cell types present in the mixed sample.

The present disclosure includes a step of ranking biomarkers so that only those biomarkers that are most-informative for identification of a biological sample or cell type are selected and used for the next step in the pipeline. By ranking and selecting biomarkers that are most-informative for identification of cell types, a smaller number of biomarkers will generate a more rapid increase in probability that identification of the cell type is accurate, as compared against conventional techniques where biomarkers are selected on an ad hoc or random basis. In this way, the biomarker panel can be rationally designed to meet the end user's specifications for accuracy, cost, volume, and experimental constraints.

The present disclosure provides a multi-step process for the selection, accuracy and analysis of biomarker panels. Generally, the steps include statistically-designed and rigorous ranking and selecting of biomarkers, applying a cost-benefit analysis to pre-determine the optimal biomarker panel (panel size and biomarker type) tailored to meet the requirements of the end user, and interpreting biomarker assay results to identify the cell type(s) in the sample, along with probabilities that the identification is accurate to a high degree of confidence.

More specifically, the present method provides a first step where biomarkers from the relevant, user-provided sample set are analyzed using a sequence of steps in an algorithm. The biomarkers are ranked from most informative to least informative as to their abilities to discriminate among the individual cell types in the sample.

Next, the ranking of biomarkers generated in the previous step is fed to the next step in the pipeline of selecting the most appropriate biomarker panel size, based on experimental constraints and the needs for accuracy, cost and throughput needs of the end user. Depending on the specific needs, an end user may be willing to sacrifice a bit of accuracy for the ability to input a large volume of unknown samples through the pipeline, or, conversely, may require great accuracy at increased cost or by reducing the throughput speed. Simulations are run utilizing different numbers and sets of biomarkers established in the earlier step, and the probabilities that the identification of the cell type is accurate can be determined for different biomarker sets in the simulations. The results of this step can be displayed as a graph displaying the accuracy rate vs. the number of biomarkers, or as a table showing the accuracy for common assay formats based on standard 96- and 384-well plates. With this information, the most-efficient biomarker panel size and/or type can be selected in accordance with the experimental and/or economic requirements of the end-user. As shown in the disclosure below, up to a certain point, accuracy generally increases as the number of biomarkers increases; however, if the biomarkers are ranked and selected well in the earlier step, there is a diminishing incremental increase in accuracy even when more biomarkers are utilized. In this way, the pipeline decreases waste in resources by avoiding using ever-larger biomarker panels that do not produce a corresponding increase in accuracy. This curve also provides an indication of the robustness of a given panel to individual biomarker measurement errors.

After processing the samples with the selected biomarker panel, the next step in the pipeline is interpreting the biomarker assay results by comparing them with reference data to identify the sample, and ranking possible matches in cell type identity from best-match to least-good match. The output of this step is provided as a table and/or graphically, displaying matches in ranked order. This pipeline for rational design and interpretation of biomarker panels is a cost-effective method that produces results that are more accurate (and provide a numerical estimate of certainty in the identification of cell type) and reliable than those methods and systems currently in use.

Thus, one embodiment of the present disclosure comprises a method for identifying a biological sample comprising: identifying a plurality of biomarkers that are indicia of the identity of the biological sample; ranking the identified biomarkers from most-informative to least-informative to generate a ranked biomarker set; selecting a biomarker panel using the ranked biomarker set and determining the size and contents of the biomarker panel; using the biomarker panel to assay the biological sample to generate a biomarker assay output; and comparing the biomarker assay output to reference data for the biomarkers in the biomarker panel to rank the biomarkers in the biomarker assay output from best-match to least-match as compared with the reference data to identify the biological sample.

Another embodiment of the present disclosure includes a method for identifying and/or characterizing a biological sample using a pipeline comprising: ranking a plurality of biomarkers that are indicia of the identity of the biological sample using an algorithm that generates a ranked biomarker set; selecting a biomarker panel by a series of simulations that use the ranked biomarker set to determine a size and content of the biomarker panel that are tailored to the specifications of an end-user; using the selected biomarker panel to assay the biological sample; interpreting the results of the assay from best-match to least-match as compared with reference data to identify and/or characterize the biological sample.

An additional embodiment of the present disclosure includes a method for selecting a biomarker panel for characterization and/or identification of a biological sample by a pipeline comprising: selecting a plurality of biomarkers that characterize and/or identify the biological sample; ranking the biomarkers by a sequence of steps from most-informative to least-informative to generate a ranked biomarker set; and selecting a biomarker panel using the ranked biomarker set by a series of simulations that determine the size and contents of the biomarker panel.

A further embodiment of the present disclosure includes a method for generating a biomarker assay output for characterizing or identifying a biological sample by a pipeline comprising: selecting a plurality of biomarkers that characterize or identify the biological sample; ranking the biomarkers from most-informative to least-informative by a sequence of steps that generate a ranked biomarker set for characterization or identification of the biological sample; selecting a biomarker panel by a series of simulations using the ranked biomarker set that determine the size and contents of the biomarker panel; and assaying the biological sample using the selected biomarker panel to generate a biomarker assay output.

A still further embodiment of the present disclosure includes a method for generating a biomarker results set for characterizing or identifying a biological sample by a pipeline comprising: selecting a plurality of biomarkers that correspond to the biological sample; ranking the biomarkers from most-informative to least-informative by a sequence of steps that generate a ranked biomarker set for characterization or identification of the biological sample using the ranked biomarker set in a series of simulations to select the size and contents of a biomarker panel that correspond to the specifications of an end-user for accuracy, economy and/or throughput; using the selected biomarker panel to assay the biological sample to generate a biomarker assay output; and comparing the biomarker assay output to reference data for the biomarkers in the biomarker panel to generate a biomarker results set.

An additional further embodiment of the present disclosure is a method for selecting a biomarker panel for characterization or identification of a biological sample by a pipeline comprising: selecting a plurality of biomarkers that characterize or identify the biological sample; ranking the biomarkers, by a sequence of steps, from most-informative to least-informative to generate a ranked biomarker set; and selecting a biomarker panel using the ranked biomarker set by a series of simulations that determine the size and contents of the biomarker panel corresponding to the specifications of an end-user.

Another embodiment of the present disclosure includes methods ranking one or more biomarker set, the one or more ranked biomarker set obtained by the ranking, and using the one of more ranked biomarker set.

These and other embodiments will become apparent to those of skill in the art based upon the following detailed disclosure and the examples that follow.

### BRIEF DESCRIPTION OF THE DRAWINGS

FIG. 1 shows the sequence of steps of a greedy algorithm as an exemplary embodiment of a step in the method to approximate the Integer Linear Programming (ILP) problem, to identify a subset of biomarkers that are the most-informative in distinguishing among different cell types. The ranking of biomarkers can be performed by other algorithms in other exemplary embodiments of this step.

FIG. 2 shows an example of an ROC (Receiver Operating Characteristic) curve showing True Positive Rate (TPR) (y-axis) vs. False Positive Rate (FPR) (x-axis), displaying the trade-off between TPR and FPR in the present method.

FIG. 3 shows beta density functions at different coverage rates.

Note: In each of FIG. 4A to FIG. 9, the presence of ellipses ( . . . ) inside a box indicates there are additional cell types of the same kind as the cell type identified in that box.

FIG. 4A illustrates the major lineages derived from the mesoderm. FIG. 4B outlines lineage development leading up to myeloid and lymphoid cell types.

FIG. 5 shows cell types derived from the chordamesoderm and lateral mesoderm, including notochord, smooth muscle, and cardiac cell types.

FIG. 6 shows cell types derived from intermediate mesoderm, including kidney and gonad cell types.

FIG. 7 shows cell types derived from paraxial mesoderm, including skeletal muscle, brown/white fat, chondrocyte, osteocyte, and tendon cell types.

FIG. 8 shows cell types derived from myeloid stem cells, including macrophage, neutrophil, mast, basophil, platelet and erythrocytes cell types.

FIG. 9 shows cell types derived from the lymphoid stem, including b cells, t cells, and nk cells.

FIG. 10 shows two exemplary embodiments of combining cell types (or reference samples of any type). FIG. 10A shows combining cell types based on the number of markers per cell type, where cell types labeled B and E and C and G have been merged together to create a cell type containing 11 and 14 markers, respectively. FIG. 10B shows combining cell types to create regions, where two groups of cells types (B, D, and E) and (C, F and G) have been combined to create a single cell type for each group.

FIG. 11A is an algorithm to merge cell types based on minimum number of markers per cell type, and FIG. 11B is an algorithm to merge cell types to generate regions for an exemplary embodiment of the present method.

FIG. 12 is a graphical representation of an exemplary embodiment of a simulation of the present method for calculating the accuracy rate of a set of markers from 12 to 384 markers, where the y-axis is the % accuracy rate and the x-axis is the number of markers used in the 96- and 384-well plates.

FIG. 13 displays the results of the matching step in an exemplary embodiment of the present method, where the lineage displays the same cell types mapped back to a lineage map containing all of the cell type, and matches are ranked from in gray scale from dark (highest probability of match) to light (least probability of match).

FIG. 14 displays the results of the matching step in another exemplary embodiment of the present method, where the lineage displays the same cell types mapped back to a lineage map containing all of the cell type, and matches are ranked from in gray scale from dark (highest probability of match) to light (least probability of match).

### DETAILED DESCRIPTION OF THE DISCLOSURE

A pipeline is provided for the rational design and interpretation of biomarker panels that can accurately and efficiently identify unknown cell types in a sample, and distinguish among cell types therein to a high degree of certainty.

The pipeline includes a sequence of steps that include: generating a maximally-informative marker set from a biomarker database or databases; determining a biomarker panel through simulations that establishes the optimal biomarker panel tailored to meet the end user's needs for accuracy, cost, volume and speed; and matching results from these assays with reference samples in order to provide a statistically robust interpretation of the biomarker assay. The pipeline can accurately and efficiently assess the identity of unknown cell types; for instance, identifying unknown progenitor cell types from a mesodermal lineage.

As used in this application, “pipeline” means a sequence of steps. In general, the output generated by each step is fed to the next step in the sequence as an input, and the steps are performed in order.

As used in this application, “indicia” means the features or characteristics that can be used, alone or in combination, as indicators of the identity of a biological sample and/or to distinguish or discriminate among cell types.

Unlike some conventional methods that can distinguish between only two conditions or states—for instance, as between “disease state” and “non-disease state”—the pipeline disclosed herein is capable of discriminating between an unlimited number of different conditions or cell types. Moreover, unlike conventional methods, the pipeline permits the biomarker panel to be tailored so that the end user can select (“dial up” or “dial down”) the desired level of accuracy of the biomarker panels, as balanced against the user's specifications for cost, volume, and/or throughput. For instance, as will be shown below, the present method can be optimized to accommodate one end user whose requirements are to discriminate among cell types with such high levels of accuracy to establish precisely which “box” that his unknown cells are in; yet another end user may only need to establish whether unknown cell types are either “X” cells or “not-X” cells, and does not need any further information about the features of the “not-X” cells. More specifically, one end user may require a pipeline that provides an exceptionally low rate of “false positive” results because the impact of a false positive result could be catastrophic, yet a different end user may require biomarker panels to screen a large library of samples where the rate of false positives may not be critical; e.g., the primary attributes in selecting biomarker panels is screening for potential positives with exceptionally high throughput and very low cost, and an occasional false positive would cause few problems. This pipeline can be tailored to the specifications of the end user readily at the first step (i.e., selection of the biomarker set), as well as the step of “matching” the assay results to set of reference data.

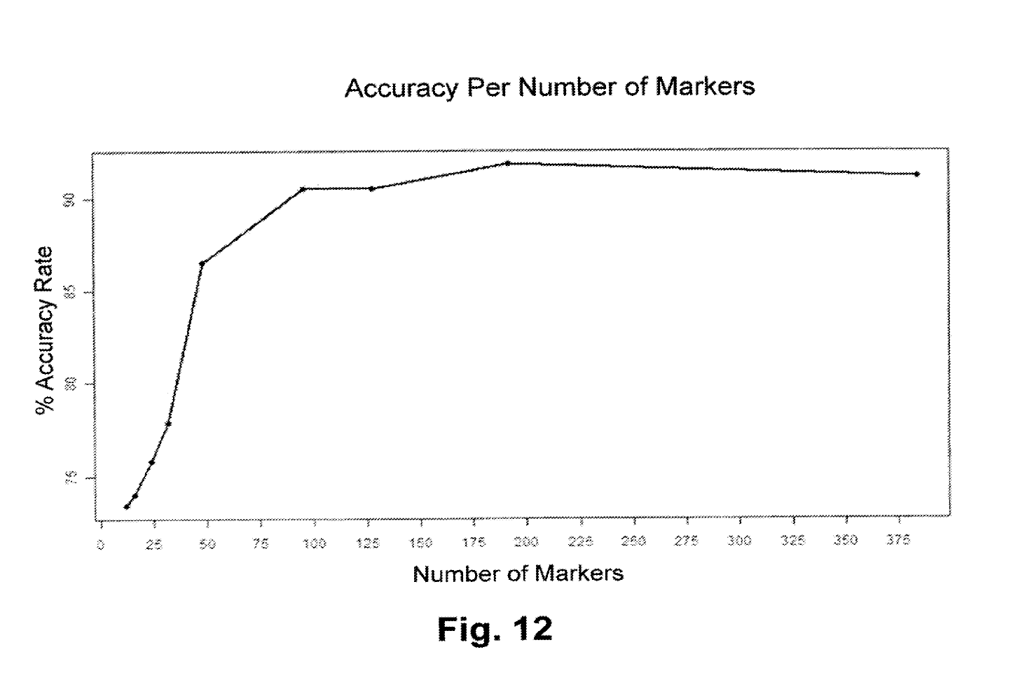

As shown in conventional approaches, if a single biomarker is used, and there is sufficient “noise” in the process, the result might be false. Generally, a larger number of biomarkers will give more accuracy (and certainty) in identifying cell types. Yet using an ever-larger number of biomarkers increases the experimental and analytical burdens, as well as cost. However, the present pipeline uses simulations employing the ranked biomarker output set to determine precisely how much of an incremental increase in accuracy is gained (or lost) by adding additional biomarkers to the biomarker panel. Unexpectedly, it was found that the present method, by ranking and selecting biomarkers from the most-to-least informative in the initial step, and feeding that ranked biomarker set output into the next step (to determine how much accuracy increases when the number of biomarkers is increased), that the incremental increase in accuracy rises sharply as more biomarkers are added, but only up to a certain point. After this point, the accuracy curve flattens out, as gains in accuracy are minimal even as more and more biomarkers are used. An example of this unexpected effect is provided later in this disclosure (and shown graphically in FIG. 12), where an increase from 12 biomarkers (73% accuracy) to 96 biomarkers (91% accuracy) showed considerable gains in percentage of accuracy (i.e., certainty), but increasing the number of biomarkers tested beyond 96 markers produces little or no corresponding gains in accuracy (128 biomarkers—91% accuracy; 192 biomarkers—92% accuracy; and 384 biomarkers—91% accuracy). One embodiment of the pipeline automatically calculates the “sweet spot” of accuracy vs. number of biomarkers in the panel—which may differ depending on the end user's requirements; for example, that the pipeline will identify the biomarker panel size where accuracy increases less than a pre-determined amount (such as <0.1%) as another biomarker is added. Again, since this step is preceded in this pipeline by ranking biomarkers from most-informative to least-informative, each successive biomarker added in this method will produce fewer gains in accuracy as compared to conventional approaches that select biomarkers for the biomarker panel on an ad hoc or random basis.

Where the sample containing the unknown cell types is unknown even as to the origin of the body site—i.e., the unknown cell(s) might be from prostate tissue, or breast tissue, or vascular endothelial tissue—the pipeline may further include a preliminary step, so that the process is: (1) determine whether the unknown cell is, generally, a prostate cell, a breast epithelial cell, or a vascular tissue cell; and (2) once the general cell type is identified (for example, that the unknown cell is identified as a breast epithelial cell), then use the pipeline in this disclosure to determine the probabilities that the unknown cell type is a breast epithelial Type I cell, breast epithelial Type II cell. Steps (1) and (2) can be operated together; however, high throughput may have to be sacrificed to perform these steps together. For this reason, preliminary step (1) can be conducted separately from the normal operation of the pipeline in step (2), so that the pipeline can operate at a high throughput.

The input of the pipeline is biomarkers that include, but are not limited to, RNA, proteins, antibodies, DNA, and small molecules (such as metabolites). The pipeline technology disclosed herein is “technology independent.” In a preferred embodiment, RNA biomarkers are employed, because RNA biomarkers generally contain more information about the cell type than other markers, and also because RNA markers are relatively simple to identify and measure. Proteins, and metabolites, are also relatively simple to identify with mass spectroscopy. As an example, the pipeline could be run on large numbers of urine samples to analyze the metabolites or other biomarkers present, and tie the findings to a particular disease state, such as trauma.

The pipeline of the present disclosure obtains its results by the combination of the several steps presented herein, and by the order of steps, such that the output of each step is fed as an input to the next step. The steps and sequence in the pipeline are described in detail below.

### Assay Design

Given n cell types with associated p-marker expression profiles, it is desirable to find a subset of markers that allows distinguishing one cell type from another. This can be regarded as a supervised feature selection problem, where each cell type forms a class of one instance and the goal is to find a subset of markers achieving high classification accuracy. However, due to the sparseness of the expression data, standard feature selection algorithms are not applicable. Therefore, in the present disclosure, the problem was formulated as an integer linear programming (ILP) problem. Assume that E=(Eᵢⱼ) is considered to be the n×p expression matrix, where Eᵢⱼε{−1, 1, 0} and −1, 1, and 0 denote that marker j is absent, present and unknown in cell type i, respectively. Since the quality of Eᵢⱼ varies depending on how the value is determined, a quality score Qᵢⱼ (ε[0, 1]) can be assigned to Eᵢⱼ for all i and j. Dⱼ(i₁, i₂) denotes the Hamming distance between cell types i₁ and i₂ indexed by marker j. The ILP then is:

$$\begin{matrix}{min}_{{x}_{j} , j = 1 , … , p} {\sum }_{j = 1}^{p} {x}_{j} subject to & ( 1 ) \\ {\sum }_{j = 1}^{p} {x}_{j} {D}_{j} ( {i}_{1} , {i}_{2} ) \geq δ ∀ {i}_{1} , {i}_{2} = 1 , ⋯ , n , {i}_{1} < {i}_{2} & ( 2 ) \\ {\sum }_{j = 1}^{p} {x}_{j} {Q}_{ij} \geq β {∀}_{i} = 1 , ⋯ , n & ( 3 ) \\ {θ}_{m i n} \leq {\sum }_{j = 1}^{p} {x}_{j} \leq {θ}_{m ax} \\ {x}_{j} ∈ \{ 0 , 1 \} {∀}_{j} = 1 , ⋯ , p & ( 4 )\end{matrix}$$

Allowing x=(x₁ x₂ . . . xₚ) and Mₓ={j|xⱼ=1} to denote the set of chosen markers, then marker j is selected if and only if xⱼ=1. The objective function in equation (1) seeks to minimize the number of selected markers. The constraint in equation (2) requires that, for any two cell types, their distance induced by markers in Mₓ must be at least δ. The constraint in equation (3) ensures, for each cell type, the sum of quality scores of markers in Mₓ is at least β. The constraint in equation (4) ensures that at least θₘᵢₙ and at most θₘₐₓ markers are selected.

The above ILP problem reduces to a classical minimum set covering problem (MSCP) when the variables are set as δ=1, β=0, θₘᵢₙ=1, and θₘₐₓ=p. In the context of the MSCP, there are p sets and set Sⱼ={(i₁, i₂)|i₁<i₂ and Dⱼ(i₁, i₂)=1}. The goal is to find a smallest collection of sets, C, such that u_{SεC}S={(i₁, i₂)|i₁<i₂}. Table 1 shows an example 3-marker expression profile of 4 cell types.

TABLE 1
An Example of Expression Matrix

| | Marker | | |
|---|---|---|---|
| Cell Type | 1 | 2 | 3 |
| 1 | 1 | 1 | 0 |
| 2 | 0 | −1 | 0 |
| 3 | 1 | 0 | 0 |
| 4 | 0 | 0 | 1 |

Based on this expression matrix, the 3 sets are listed in Table 2, where “1” denotes presence and “0” denotes absence of a pair in a set. Set Sᵢ contains cell type pairs that are separable by marker i. It can be seen that {S₁, S₂} and {S₂, S₃} are two smallest collections of sets covering all the pairs.

TABLE 2
The Sets Induced by the Example Expression Matrix

| Cell Type | Set | | |
|---|---|---|---|
| Pair | S₁ | S₂ | S₃ |
| (1, 2) | 1 | 1 | 0 |
| (1, 3) | 0 | 1 | 0 |
| (1, 4) | 1 | 1 | 1 |
| (2, 3) | 1 | 1 | 0 |
| (2, 4) | 0 | 1 | 1 |
| (3, 4) | 1 | 0 | 1 |

MSCP is known to be NP-hard and thus solving the ILP in (1) directly is very time-consuming for large n and p. Therefore, a greedy algorithm for finding a near-optimal solution to (1) can be used. First, define Dₓ(i₁,i₂)=Σⱼ₌₁^{p}ΣxⱼQᵢⱼ, the distance between cell types i₁ and i₂ induced by marker set Mₓ, and Qₓ(i)=Σⱼ₌₁^{p}xⱼQᵢⱼ, the quality of cell type i induced by marker set Mₓ. Then let kε{j|xⱼ=0} be a marker that hasn't been selected and xₖ=(x₁ . . . xₖ₋₁ 1 xₖ₌₁ . . . xₚ). Also defined are the following three functions to gauge the improvement made by selecting marker k:

$${∅}_{{x}_{k}} = {max}_{{i}_{1} < {i}_{2}} {D}_{{X}^{k}} ( {i}_{1} , {i}_{2} ) - {min}_{{i}_{1} < {i}_{2}} {D}_{{X}^{k}} ( {i}_{1} , {i}_{2} )$$

$$Δ {D}_{k} = {\sum }_{{i}_{1} < {i}_{2}} {D}_{k} ( {i}_{1} , {i}_{2} ) I ( {D}_{x} ( {i}_{1} , {i}_{2} ) < δ )$$

$$Δ {Q}_{k} = {\sum }_{i = 1}^{n} {Q}_{ik} I ( {Q}_{x} ( i ) < β ) \\$$

where I(cond) is the indicator function, where I(cond)=1 if cond is true, otherwise I(cond)=0. ₓ_{ₖ} gives the difference between the maximal and minimal distances between cell types when marker k is introduced to the set of markers. considers pairs of cell types violating the constraint in (2) and measures the improvement made by including marker k. Similarly, ΔQₖ takes into account cell types violating the constraint in (3) and gauges the effect of choosing marker k. For each iteration, marker k is chosen such that ₓ_{ₖ} is minimized while and ΔQₖ are maximized.

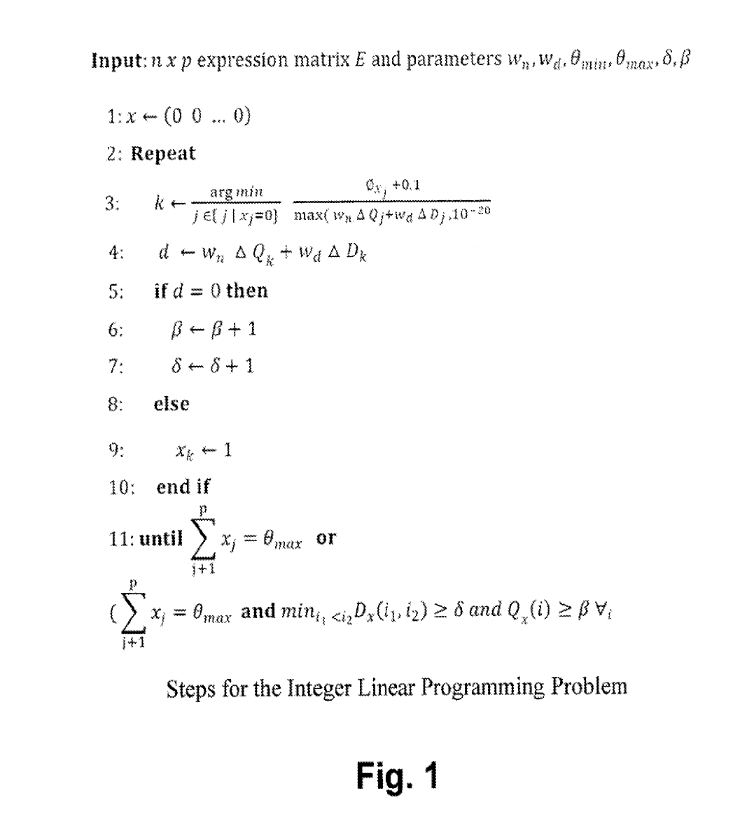

Referring now to FIG. 1, an example of a greedy algorithm is provided. Two additional parameters, ω_{d} and ωₙ, are introduced to fine-tune the importance of these three marker-choosing criteria. In case ΔDₖ and ΔQₖ are both zero, no marker is picked at this iteration. Instead, the algorithm increases the quality threshold δ and the distance threshold β by one. This ensures that not both of ΔDₖ and ΔQₖ are zero at the next iteration.

### Cell Type Retrieval

It is then assumed that each cell type is described by q markers selected by the greedy algorithm proposed above. Given the q-marker expression profile of an unknown tissue sample, it would be useful to identify its cell type by searching for cell types with similar expression profiles in a database. To this end, each cell type in the database is scored by its similarity to the unknown sample. The unknown sample is assumed to be a=a₁ a₂ . . . a_{q}), and b=b₁ b₂ . . . b_{q}) is a cell type in the database. Then b is scored by

Scoreₐ(b)=Sim(a,b) (5)

Cell types in the database can then be ranked by score in descending order. The K highest scoring cell types are then returned to the users for consideration. Two similarity measures are considered in this disclosure: (1) the cosine similarity and (2) the correlation coefficient. The cosine similarity between a and b is given by

$$Cos ( a , b ) = \frac{{\sum }_{i = 1}^{q} {a}_{i} {b}_{i}}{\vert \vert a \vert \vert \vert \vert b \vert \vert} \qquad ( 6 )$$

where ∥a˜=\sqrt{Σᵢ₌₁^{q}a₁²} is the length of a and ∥b∥ is similarly defined. On the other hand, allowing ā=q⁻¹Σᵢ₌₁^{q}a₁, ā=*a₁−ā a₂−ā . . . a_{q}−ā), and likewise b̅ and b, the correlation coefficient between a and b is defined as

Cos(a,b)=Cos(a−ā,b− b̅). (7)

Thus, it can be seen that Cor(a, b) coincides with Cos(a, b) when ā= b̅=0. Suppose that the lineage of n cell types in the database is available. Confidence about the score of cell type b is greater if its neighboring cell types in the lineage receive comparable scores. For this reason, Score a(b) is smoothed by a weighted mean filter as follows:

$${Score}_{a}^{s} ( b ) = \frac{{\sum }_{c ∈ C} {W}_{b , c} {Score}_{a} ( c )}{{\sum }_{c ∈ C} {W}_{b , c}} \qquad ( 8 )$$

where C is the set of n expression profiles, and w_{b,c}=exp(−γD^{L}(b,c)), γ=0.25 and D^{L}(b,c) is the distance between cell types b and c in the lineage. The distance between two cell types in the lineage is given by the least number of “hops” needed to go from one cell type to the other.

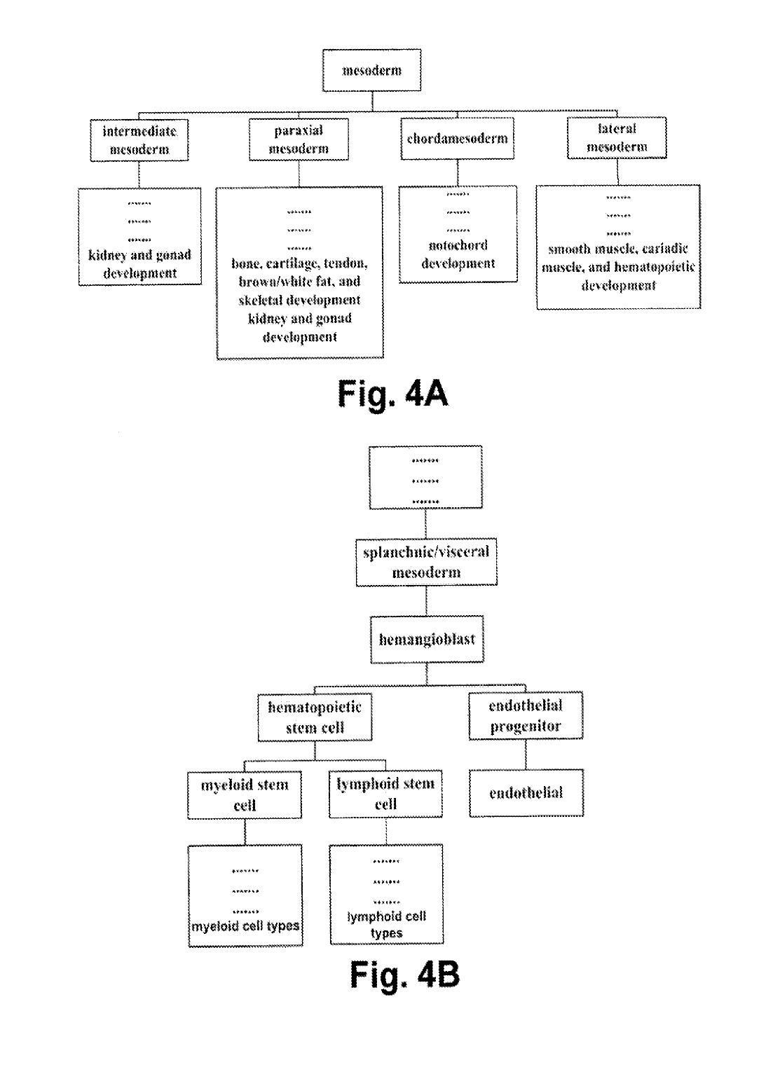

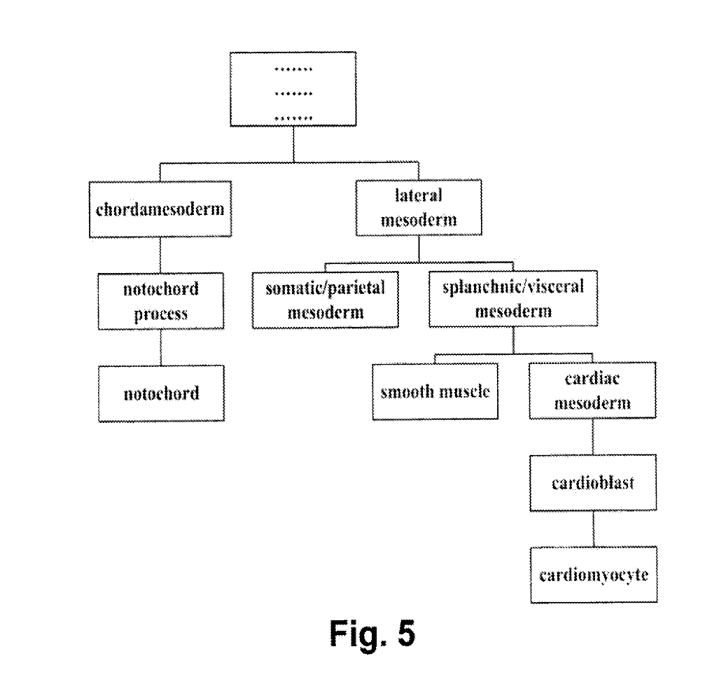

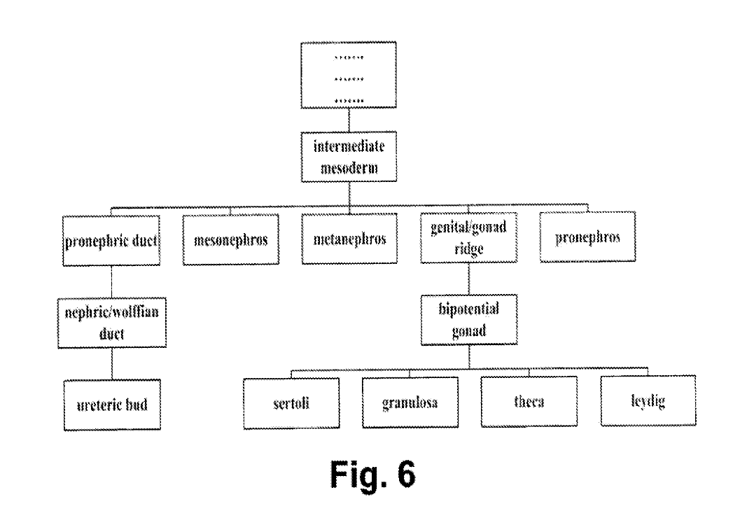

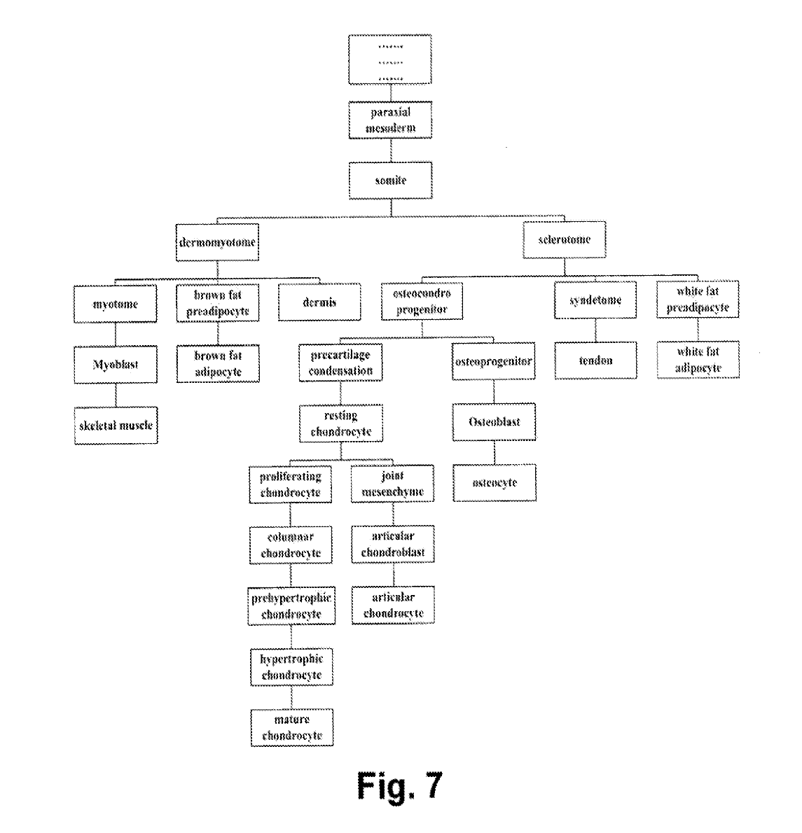

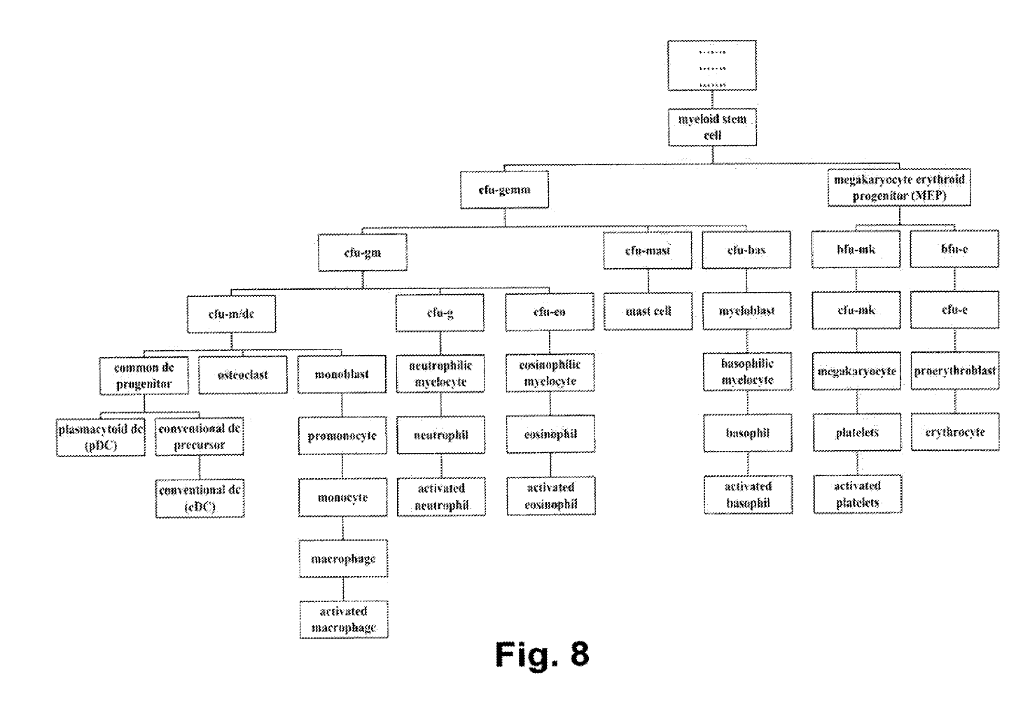

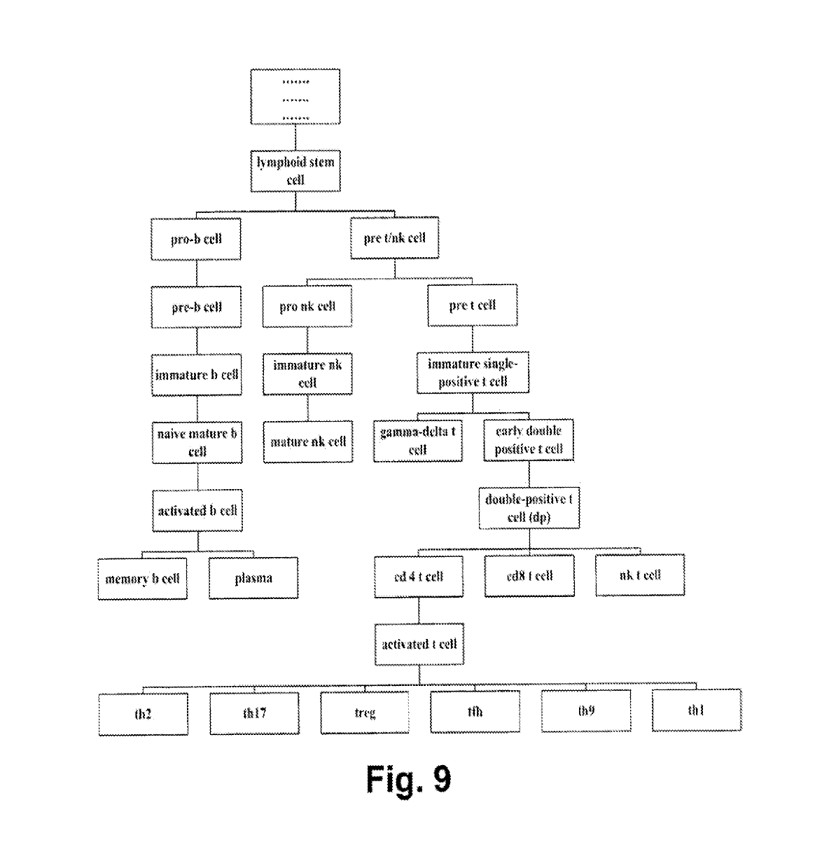

FIG. 4A to FIG. 9 illustrate various cell type lineages for cells referenced in this application. For each of FIG. 4A to FIG. 9, the presence of ellipses ( . . . ) inside a box indicates there are additional cell types of the same kind as the cell type identified in that box. Specifically, FIG. 4A illustrates the major lineages derived from the mesoderm. FIG. 4B outlines lineage development leading up to myeloid and lymphoid cell types. FIG. 5 shows cell types derived from the chordamesoderm and lateral mesoderm, including notochord, smooth muscle, and cardiac cell types. FIG. 6 shows cell types derived from intermediate mesoderm, including kidney and gonad cell types. FIG. 7 shows cell types derived from paraxial mesoderm, including skeletal muscle, brown/white fat, chondrocyte, osteocyte, and tendon cell types. FIG. 8 shows cell types derived from myeloid stem cells, including macrophage, neutrophil, mast, basophil, platelet and erythrocytes cell types. And FIG. 9 shows cell types derived from the lymphoid stem, including b cells, t cells, and nk cells.

### Performance Evaluation

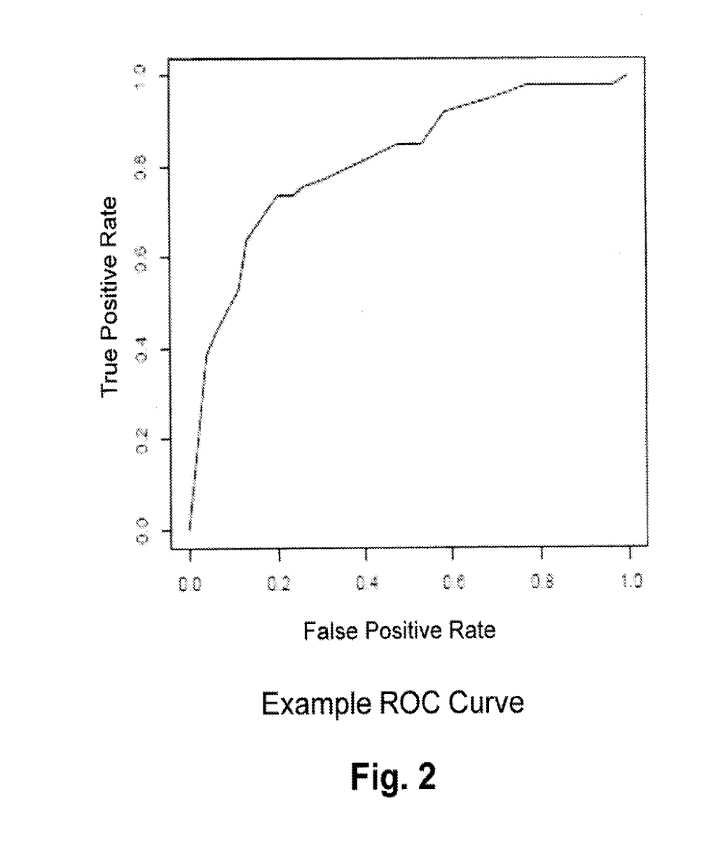

The area under the ROC curve (AUC) was used to gauge the performance of a marker panel. The ROC curve is a plot of true positive rate (TPR) against false positive rate (FPR), displaying the trade-off between TPR and FPR. FIG. 2 shows an example of an ROC curve, which shows that the TPR is 0.85 when the FPR is around 0.5, the TPR increases to 0.92 when the FPR is around 0.6, and so on. The AUC ranges from 0 to 1. A high AUC indicates good performance, as it implies that high TPF can be obtained at low FPR. Assume that a panel of q markers has been selected using the greedy algorithm on a database of n cell types. To assess the performance of this marker panel, an independent set of expression profiles can be utilized. Specifically, given a test set of m profiles whose cell types are known, the expression of the q chosen markers can be extracted from each profile. Moreover, cell types present in the test set are present in the database as well. Each test profile is then searched against the database such that a similarity score is assigned to each of the n cell types in the database. Table 3 shows an example of similarity scores between m=4 test profiles and n=12 cell types in the database.

TABLE 3
Similarity Scores Between 4 Test Profiles and 12 Cell Types

Cell Types

| Profile | 1 | 2 | 3 | . . . | 11 | 12 |
|---|---|---|---|---|---|---|
| 1 | −0.1 | 0.5 | 0.3 | . . . | 0.5 | 0.7 |
| 2 | −0.2 | 0.2 | 0.1 | . . . | 0.3 | 0.4 |
| 3 | 0.2 | 0.2 | 0.4 | . . . | 0.4 | 0.6 |
| 4 | 0.1 | 0 | 0.1 | . . . | −0.2 | −0.5 |

To plot the ROC curve for the search results in Table 3, first the n=12 cell types for each test profile were ranked. Table 4 shows the ranks of the 12 cell types for each test profile. For each test profile, the candidate cell types are those with ranks less than or equal to k.

TABLE 4
Ranks of the 12 Cell Types for each Test Profile

Cell Types

| Profile | 1 | 2 | 3 | . . . | 11 | 12 |
|---|---|---|---|---|---|---|
| 1 | 7 | 2 | 4 | . . . | 2 | 1 |
| 2 | 11 | 6 | 7 | . . . | 3 | 2 |
| 3 | 6 | 6 | 3 | . . . | 3 | 1 |
| 4 | 1 | 3 | 1 | . . . | 6 | 12 |

Table 5 shows the candidate cell types for each profile when k=2, that is, cell types whose rank is 1 or 2 are selected as candidates. In this case, the TPR is 0.75 (3 out of 4) and the FPR is around 0.16 (7 out of 44). The ROC curve can then be approximated by computing the TPR and FPR for kε{0, 1, . . . , n=12}.

TABLE 5
Candidate Cell Types for each Test Profile

| | True Cell | Candidate Cell |
|---|---|---|
| Profile | Type | Types |
| 1 | 11 | 2, 11, 12 |
| 2 | 3 | 4, 12 |
| 3 | 8 | 8, 12 |
| 4 | 1 | 1, 3, 9 |

Given a lineage of the n cell types in the database, the computation of TPR can be further refined. Considering a test profile, first the distance between each candidate cell type to the true cell type is computed based on the lineage. A score is computed for each candidate by 2^{-d}, where d is the distance between the candidate and the true cell type in the lineage. The true positive score is the maximal score across all the candidates. Table 6 shows an example. In this case, the TPR is 3.25/4 and the FPR is 6.75/44 since the true positive scores sum to 3.25.

TABLE 6
Example of Refined True Positive Rate Calculation

| | | | | True |
|---|---|---|---|---|
| | True Cell | | | Positive |
| Profile | Type | Distance | Score(s) | Score |
| 1 | 11 | 1, 0, 4 | 2⁻¹, 1, 2⁻⁴ | 1 |
| 2 | 3 | 2, 5 | 2⁻¹, 2⁻⁵ | 2⁻² |
| 3 | 8 | 0, 1 | 1, 2⁻¹ | 1 |
| 4 | 1 | 0, 3, 2 | 1, 2⁻³, 2⁻² | 1 |

### Leave-One-Out Cross Validation

In those cases where no test profiles are available, then “leave-one-out cross-validation” (LOO CV) is performed on the n cell types in the database, assuming that a lineage of the n cell types is available. At each iteration, a cell type is left out as the test cell type, and the other n−1 cell types are used to select a panel of q markers. This test cell type is then searched against the n−1 cell types using the chosen marker panel. The TPR is then calculated as above with one change. Now that the test cell type is left out, it can never be matched to itself. The best case scenario is to map it to an adjacent cell type in the lineage. Hence, the score of a candidate by 2^{-(d-1)} is computed, where d is the distance between the candidate and the true cell type. In this way, a candidate cell type gets a score of 1 if it is adjacent to the true cell type. After n iterations, the ROC curve can be plotted and the AUC computed as described above. To determine the size of a marker panel, the number markers q in a range, e.g., {6, 7 . . . 96} can be searched. The panel size can then be picked to be the q yielding the highest AUC.

### Merge Cell Types

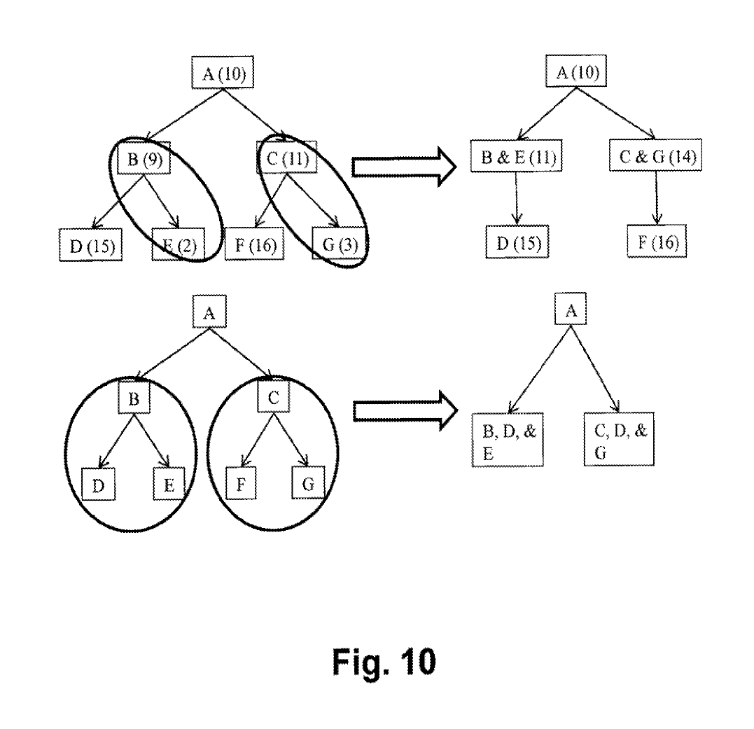

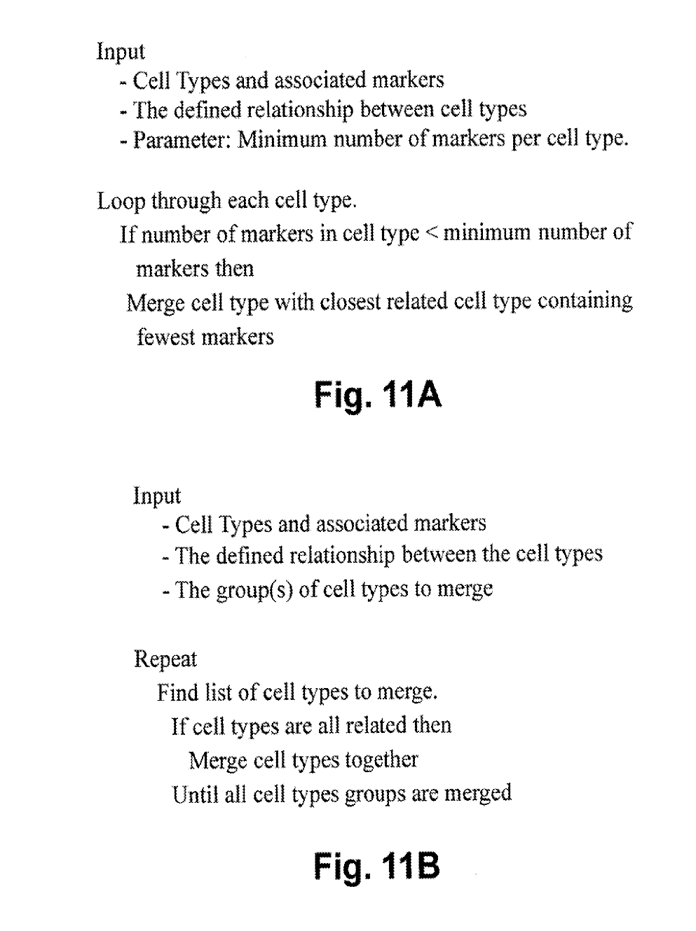

If a relationship exists between cell types, under certain conditions it may be beneficial to combine multiple cell types into a single cell type. In some cases, it may not be possible to obtain a marker profile to adequately represent all the cell types. This can be addressed by merging all cell types, as shown in FIG. 10A, and by the algorithm in FIG. 11A, under a certain marker size with its neighbor(s) to ensure a minimum number of markers per cell type. In other situations it may be only necessary to identify a particular region versus a specific cell type. All cell types along a lineage branch or area, as shown in FIG. 10B, and by the algorithm in FIG. 12, can be combined to produce a single cell type to represent the entire region. In both cases the resulting cell type would be the union of markers contained in the individual cell types.

### Proof of Concept—I

### In Silico Experiment

Data published by two large academic medical centers were collected to use in a computational (in silico) experiment as proof of concept. Briefly, data from the first university was collected and input into the pipeline of the present disclosure. The outputs of the pipeline were matched against the results published by the second university. A second in silico experiment was then conducted by reversing the parties; i.e., using data from the second university as input for the pipeline of the present disclosure, and comparing its output against results published by the first university. Details of these in silico experiments are provided below.

As the marker selection algorithm is specifically designed for sparse expression data, it is beneficial to know if and how the degree of sparseness affects the cell type retrieval performance. To this end, two micro-array data sets containing expression profiles of cell types in the blood lineage were used. One contains 50 arrays across 8 cell types. The other contains 211 expression profiles across 38 hematopoietic cell populations. Twenty-eight (28) out of thirty-eight (38) populations were matched uniquely to 28 cell types in our curated lineage. Hence, the 180 out of 211 arrays across 28 cell types were used in this experiment.

The larger data set of 28 cell types was used as the reference database. The expression profiles of these cell types were summarized from the 180 arrays. Specifically, the expression of a probe on an array was first discriminated based on 1 (present) or −1 (absent). The expression of a gene on an array was given by the majority status of probes detecting this gene. That is, if the majority of these probes are marked present, the gene is marked present; conversely, if the majority of these probes are marked absent, the gene is marked absent. In case of a tie, the gene is marked 0, indicating that its expression is unknown. Finally, the expression of a gene in a cell type was obtained by summarizing the arrays of this cell type similarly by majority vote.

The 50 arrays were similarly discriminated, while array profiles were not further aggregated into cell type profiles. This data set was used as our test samples whose cell types are unknown. With a given marker panel, the cell type of each sample can be predicted by searching against the reference database. The 50 arrays were tagged with cell types in the curated lineage. This enabled assessing the performance of the algorithm in predicting the cell types of the 50 samples.

### Introduce the Curated Data Set of 28 Cell Types

In this experiment, only markers in the curated data set of 28 cell types were considered. Among these markers, 361 of them were found in the reference database. Therefore, the reference database can be viewed as a 28×361 expression matrix. The coverage of this matrix is nearly 97%, i.e., about 97% of the elements in the expression matrix are known, taking values 1 or −1. The coverage of the curated data however is about 19%. To observe the performance change as the coverage varies, the experiment started with 19% coverage and gradually increased the coverage up to 97%. All the expression matrices with different coverages were sampled from the reference database, i.e., the 97%-coverage matrix.

To sample an expression matrix of a particular coverage 19%), the coverage of a marker was considered; i.e., the fraction of cell types having known expression statuses for the marker. The coverage of a matrix is equivalent to the mean of the marker-wise coverages. An assumption was made that the coverage of a marker follows a beta distribution with positive shape parameters, a and b, Beta(a,b). First, the parameters using the marker-wise coverage of the 19%-coverage curated data set were estimated, allowing the two estimates to be â and \hat{b}. These estimates were used to sample random matrices of 19% coverage. Specifically, the coverage of each marker was sampled from Beta(â,\hat{b}). The cell types having a known status for this marker were randomly picked to satisfy the desired coverage. The exact status of a marker in a cell type was taken from the reference database. To sample a random matrix of coverage 19%<μ<97%, compute

$${\hat{a}}^{′} = \frac{\hat{b} μ}{1 - μ}$$

and sample maker-wise coverages from Beta(â′,\hat{b}).

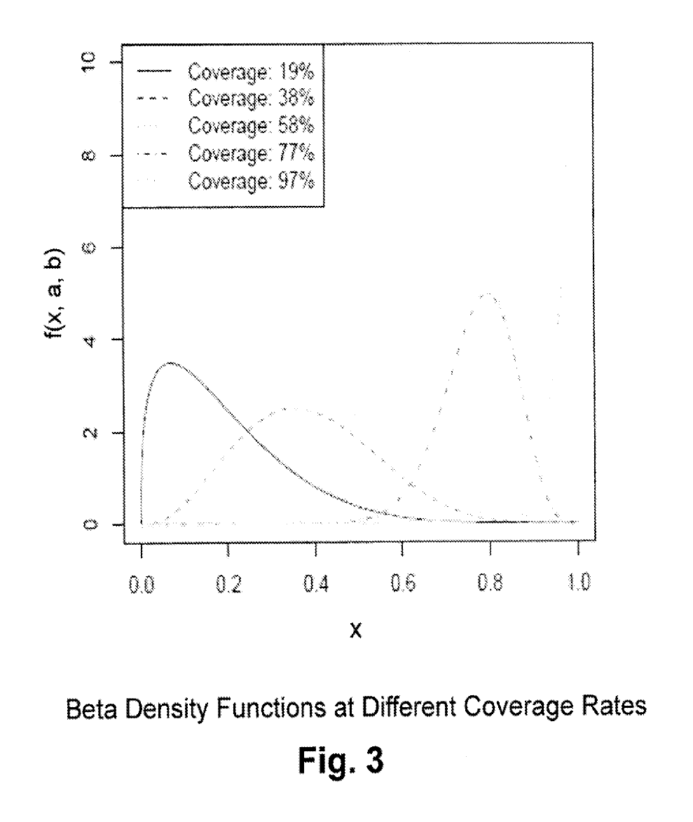

In this experiment, 5 coverage rates were considered that were equally spaced from 19% to 97%. The density functions of these beta distributions are shown in FIG. 3. Except for 97% coverage, the sampling procedure was repeated twenty (20) times for each coverage rate. The greedy algorithm was applied to each sampled matrix to obtain a panel of q markers, where q varies from 5 to the number of distinct markers in this matrix. The fifty (50) test samples were searched against the reference database using the marker panel. The AUC score was computed to gauge the search performance. This allowed the observation of the combined effects of coverage rate and marker panel size on performance.

### Proof of Concept—II

A study was conducted to test the accuracy of the pipeline at predicting the composition of unknown samples of differentiating human embryonic stem cells co-cultured with the mesodermal OP9 bone marrow stromal cell line.

The preliminary results of the study showed that the pipeline was able to accurately predict the cell types present in FACS fractionated samples of highly heterogeneous mixtures of differentiating stem cells in the cultures. The accuracy of the pipeline predictions was confirmed by the terminal differentiation and characterization of specific cell types from the identified fractions.

### Proof of Concept—III

### Wet-Lab Experiment

To validate the methods, assay design and cell retrieval, on biological samples portions of a previous experiment are repeated that showing the results, identifying cell types, can be duplicated. In the previous experiment, hES cells were co-cultured with OP9 cells. A FACS on these cells was performed and 6 different cell populations were identified. Expression profiles for each cell population were generated using a predefined PCR array (see materials and methods) containing pluripotency markers. Through manual analysis of the expression profiles, three cell populations labeled B, C, and D were identified containing progenitor cell types for chondrogenic, myeloid, and vascular cell types respectively. Confirmation for each cell type was established using differentiation protocols deriving the appropriate cell types. Samples of each cell population, identified through the FACS (Populations A-F), were processed for long term storage.

As a further confirmation, this experiment can be repeated on the six samples, replacing the predefined PCR array with a custom PCR array designed using the assay design method, and analyzing the new expression profiles using the cell retrieval method instead of manual analysis, confirming that the same progenitor cell types can be identified.

In repeating the experiment, the first step involved designing a new PCR array. In the original experiment hES cells were co-cultured with OP9 cells which have been shown to derive the majority of hematopoietic cell types along with other mesoderm derivatives such as bone and cartilage. As the original experiment detected progenitor mesodermal cell types, the new PCR array was designed to reflect this, detecting lineage paths instead of individual cell types. Initially individual cell types and associated markers were assembled for each of these lineages. The resulting lineage map is made up of 122 cell types. This lineage was modified by collapsing cell types along lineage paths creating predefined regions. The collapsed regions include bone, cartilage, skeletal muscle, and cardiac regions. Hematopoietic regions were specified representing t cells, b cells, platelets, erythrocytes, eosinophils, neutrophils, macrophages, and basophils. This resulted in a final lineage map consisting of 47 cell types. This list of cell types and associated markers for the lineage can be found below.

### Proof of Concept—IV

In this application of the disclosure, the pipeline was used to extract maximally informative minimal biomarker sets that could be used to correctly identify patients with arthritis that would respond positively to anti-TNF treatment. The results of the pipeline were compared against eight previously published anti-TNF responder biomarker panels for size of the panel (smallest being best), sensitivity and specificity. The previously published results were gathered from Toonen et al., Validation study of existing gene expression signatures for anti-TNF treatment in patients with rheumatoid arthritis, PLoS One., 2012; 7(3):e33199. This paper reexamined and validated the performance of previously published gene sets (biomarker sets) shown to be predictive of the success of treatment with tumor necrosis factor blocking agents (anti-TNF), in patients with rheumatoid arthritis (RA) (lb.).

Toonen et al. reexamined eight published genes sets from five publications (1. Julia A. et al., An eight-gene blood expression profile predicts the response to infliximab in rheumatoid arthritis, PLoS One., 2009 Oct. 22; 4(10):e7556; 2. Lequerre T., et al., Gene profiling in white blood cells predicts infliximab responsiveness in rheumatoid arthritis, Arthritis Res. Ther., 2006; 8(4):R105; 3. Sekiguchi N., et al, Messenger ribonucleic acid expression profile in peripheral blood cells from RA patients following treatment with an anti-TNF-monoclonal antibody, infliximab, Rheumatology, 2008; 47 (6):780<last_page>788; 4. Tanino M., et al., Prediction of efficacy of anti-TNF biologic agent, infliximab, for rheumatoid arthritis patients using a comprehensive transcriptome analysis of white blood cells, Biochem. Biophys. Res. Commun., 2009 Sep. 18; 387(2):261-5; and 5. Stuhlmuller B., et al., CD11c as a transcriptional biomarker to predict response to anti-TNF monotherapy with adalimumab in patients with rheumatoid arthritis, Clin. Pharmacol. Ther., 2010 March; 87(3):311-21) using a dataset of 42 patients (GEO Reference: GSE33377), including gene expression profiles of anti-TNF responders and non-responders. For each published gene set, the corresponding expression values were selected from the 42 samples and processed as described in Toonen et al. The following steps were taken to run the pipeline on the same 42 samples. First, the raw data from GEO (Reference: GSE33377) was processed to obtain the expression values for the genes. Following this, the 1000 top differential expressed genes (responder versus non-responder) were selected from the 42 samples using a t-test to evaluate the differential expression. Through cross validation, the pipeline used the top differential expressed genes to select the best gene set across a range of predefined number of genes. For each selected gene set, the sensitivity and specificity was calculated. The resulting sensitivity and specificity for each gene set was calculated, as shown in Table 7.

As can be seen in Table 7, with only 8 genes, the specificity of the pipeline outperforms all previously published biomarker panels, and the sensitivity of the pipeline's panel outperforms all but one of the previously published biomarker panels. In this one case, Julia (1), the combined sensitivity and specificity scores of the biomarker panel derived from the present disclosure outperformed Julia (1) by 166 to 109 (a 52% improvement).

TABLE 7

| | Number of | | Sensitivity | Specificity |
|---|---|---|---|---|
| Study | Genes | Reference | (%) | (%) |
| Pipeline | 8 | | 83 | 83 |
| Lequerre | 20 | (2) | 71 | 61 |
| Stuhlmuller | 11 | (5) | 79 | 56 |
| Stuhlmuller | 82 | (5) | 67 | 56 |
| Lequerre | 8 | (2) | 71 | 28 |
| Sekiguchi | 18 | (3) | 71 | 28 |
| Julia | 8 | (1) | 92 | 17 |
| Stuhlmuller | 3 | (5) | 71 | 17 |
| Tanio | 8 | (4) | 67 | 33 |

Results of the sensitivity and specificity for the pipeline across a range of different marker set sizes are set forth in Table 8.

TABLE 8

| | Number of Markers | | | | | | | | |
|---|---|---|---|---|---|---|---|---|---|
| Metric | 8 | 12 | 24 | 48 | 96 | 256 | 512 | 1024 | 2048 |
| Sensi- | 0.83 | 0.72 | 0.5 | 0.72 | 0.39 | 0.56 | 0.61 | 0.83 | 0.94 |
| tivity | | | | | | | | | |
| Spe- | 0.83 | 0.88 | 0.83 | 0.54 | 0.75 | 0.79 | 0.71 | 0.88 | 0.96 |
| cificity | | | | | | | | | |

### Example

### Process to Select Biomarkers

In a first step, biomarkers from the relevant, user-provided set are analyzed by an algorithm that ranks biomarkers from the most-informative to the least-informative for discriminating between the individual sample types in the sample set. Table 9 provides the initial biomarker set generated in the initial step of the pipeline (biomarker ranking):

TABLE 9
Ranking of Biomarkers

| Rank | Biomarker |
|---|---|
| 1 | cd33 |
| 2 | cd34 |
| 3 | cxcr4 |
| 4 | cd24 |
| 5 | cd84 |
| . . . | . . . |
| . . . | . . . |
| 380 | ccr3 |
| 381 | itga6 |
| 382 | dmrt1 |
| 383 | camk4 |
| 384 | cdca4 |

The initial (ranked) biomarker set shown in Table 9 above was selected from the submitted cell types and associated biomarkers in Table 10. Table 10 shows an example list of cell types as input into the pipeline.

TABLE 10
List of Cell Types Input into the Pipeline

| | Number of | |
|---|---|---|
| Cell Type | Biomarkers | Sample of Biomarkers |
| hematopoietic | 73 | stat5a, mecom, tek, camk4, csf3, wasf1, abcg2, abcb5, tal1, runx1, |
| stem cell | | mcl1, atxn1, dntt, cd59, vcam1, kit, pten, abcc1, procr, . . . |
| mesoderm | 27 | tgfb2, wnt3a, gsc, tgfb1, tgfb3, wnt8a, fgf5, bmp2, atxn1, hand1, |
| | | bmp4, fabp4, cd34, ventx, nodal, myod1, foxf1, cdh2, t, . . . |
| myeloid stem cell | 16 | ikzf1, prom1, fut3, mp1, cd164, i13ra, csf2rb, mfi2, mrc2, muc1, |
| | | pvr12, cd34, spi1, cd33, pvrl1, kit, |
| plasmacytoid dc | 178 | clec4c, sirpb1, itgam, il18r1, tlr10, pdcd1lg2, cd244, itgax, il10rb, |
| | | cd58, siglec1, cd74, clec10a, siglec5, entpd1, siglec7, spib, atp1b3, |
| | | tnfrsf11a, . . . |
| cd8 t cell | 75 | ccr5, icam2, itgae, ccr3, ccr2, ccr9, ccr8, cd99, b3gat1, il7r, ccr6, |
| | | spn, il2rb, il18r1, cd8a, cd244, il3ra, klrd1, itgax, . . . |
| cfu-gemm | 18 | prom1, fut3, mp1, csf3r, mfi2, il3ra, csf2rb, hladra, epor, |
| | | il1r1, mrc2, muc1, csf2ra, pvrl2, cd34, cd33, pvrl1, kit, |
| smooth muscle | 8 | acta2, des, cald1, myh11, vim, cdh5, cnn1, calm1 |
| cfu-gm | 17 | fcgr1a, il6r, csf3r, anpep, il3ra, csf2rb, csf1r, hladra, il5ra, |
| | | il1r1, mrc2, csf2ra, pvrl2, cd34, cd33, pvrl1, il4r |
| cfu-m/dc | 9 | csf2rb, il3ra, csf1r, csf2ra, pvrl2, cd33, fut4, pvrl1, anpep |
| hemangioblast | 15 | prom1, tek, cdh5, lmo2, ace, ephb4, cdh1, runx1, podxl, t, gata1, |
| | | pecam1, vegfa, cd34, kdr |
| pre t/nk cell | 9 | cd7, cd5, il7, cd2, cd44, cd34, cd33, cd38, cd1a |
| osteocondro | 10 | thbs4, pax1, tnc, vcan, dlx6, pax9, ncam1, nkx31, runx2, sox9 |
| progenitor | | |
| cd 4 t cell | 187 | itgae, stat1, spn, stat3, il2ra, il18r1, il2rb, pdcd1lg2, cd244, itgav, |
| | | prf1,itgax, cd247, ifngr1, fcar, cd74, cd70, entpd1, siglec7, . . . |
| sclerotome | 8 | pax1, foxc2, sox6, pax9, sox5, nkx31, zic1, sox9 |
| megakaryocyte | 10 | csf2rb, il3ra, ikzf1, cd34, spi1, cd33, fut3, cd38, kit, cd164 |
| erythroid | | |
| progenitor | | |
| common dc | 2 | itgax, cd33 |
| progenitor | | |
| osteoclast | 7 | acp5, cd63, csf1r, mrc2, cd53, itgb3, tnfsf11 |
| endothelial | 156 | cd63, fut4, stat3, il18r1, f11r, pdgfrb, itgav, cd248, vim, cd58, |
| progenitor | | vcam1, tnfrsf12a, cd55, kit, cd74, procr, entpd1, jam2, alcam, . . . |
| cfu-g | 195 | cd63, itgal, itgam, fut4, mpo, spn, il18r1, tlr10, f11r, cd244, itgax, |
| | | fcar, ifngr1, cd59, il10rb, cd58, cd55, siglec5, siglec7, . . . |
| conventional | 170 | clec4c, sirpb1, itgam, il18r1, tlr10, pdcd1lg2, cd244, itgax, il10rb, |
| dc precursor | | cd58, siglec1, cd74, clec10a, siglec5, entpd1, siglec7, atp1b3, |
| | | tnfrsf11a, tnfsf13b, . . . |
| monoblast | 217 | cd63, itgal, sirpb1, itgam, fut4, abcg2, spn, il2ra, pdcd1lg2, f11cr, |
| | | cd244, itgav, msr1, itgax, cd59, ifngr1, spi1, cd58, cd55, . . . |
| cfu-bas | 190 | cd63, itgal, itgam, fut4, spn, il2ra, il18r1, tlr10, f11r, cd244, itgax, |
| | | cd59, cd58, cd55, siglec5, siglec7, ms4a1, csf3r, atp1b3, . . . |
| cardiac mesoderm | 31 | tgfb2, hes1, foxc1, foxc2, tgfbr3, nkx25, fgf1, fgf2, tbx5, hand2, |
| | | hand1, bmp10, isl1, tbx1, ndrg4, ctnnb1, six1, mef2c, foxh1, . . . |
| osteoprogenitor | 16 | igfbp3, col2a1, sparc, bgn, sil1, thpo, sp7, col1a1, dcn, runx2, |
| | | col1a2, fn1, bglap, alpl, mepe, nt5e, |
| syndetome | 7 | ecm2, col3a1, abi3bp, col24a1, col12a1, col5a1, col1a2 |
| white fat | 11 | slc27a1, lpl, cebpb, adipoq, pparg, fabp4, lep, slc2a4, nt5e, bcl6, bcl6b |
| preadipocyte | | |
| pro nk cell | 189 | cd63, sirpb2, itgal, itgam, spn, il2ra, il18r1, il2rb, f11r, cd244, prf1, |
| | | itgax, cd247, cd59, ifngr1, cd58, cd55, kit, id2, . . . |
| brown fat | 4 | lpl, pparg, fabp4, ucp1 |
| preadipocyte | | |
| myotome | 24 | acta1, acadm, tnni1, pkm2, des, myod1, dmd, pax7, mylpf, itgb1, |
| | | myog, cdh2, ttn, ldha, ache, eno3, myf5, pax3, itga7, . . . |
| pro-b cell | 100 | fut4, il18r1, tlr10, dntt, ifngr1, kit, cd72, xbp1, cd74, siglec6, |
| | | entpd1, cd70, ms4a1, jam2, tnfrsf17, tnfsf8, alcam, cd69, l1cam, . . . |
| bfu-mk | 120 | cd63, ccr4, cd99, gp1ba, icam1, gp1bb, spn, il2rb, pdgfra, mpl, f11r, |
| | | itgav, il3ra, cd14, enpp3, cd55, il6r, cd109, atp1b3, . . . |
| bfu-e | 113 | darc, art4, slc4a1, icam4, cd99, rhd, fut3, f11r, lag3, il3ra, |
| | | hladra, kel, itga5, epor, tecr, cd34, spi1, cd33, cd59, . . . |
| cfu-eo | 176 | cd63, itgal, itgam, fut4, spn, il18r1, tlr10, f11r, cd244, itgax, cd59, |
| | | cd58, cd55, siglec5, siglec7, csf3r, atp1b3, tnfsf8, cd69, . . . |
| cfu-mast | 15 | fcgr1b, cr1, cxcr1, il6r, fcgr2b, fcer2, itgam, fut4, spn, cd9, cd244, |
| | | il3ra, il5ra, csf2ra, kit |
| chordamesoderm | 85 | aebp1, nrg1, fut4, tdgf1, smad2, smoc1, foxa1, shh, sod1, npr3, gli2, |
| | | tcf12, zic2, lhx1, col2a1, nog, six1, sema5a, gad1, . . . |
| lateral mesoderm | 3 | avp, kdr, pdgfra |
| pre t cell | 31 | il7r, fcgr3b, cd8a, cd8b, sox13, tox, ptprc, cd34, cd38, trd@, |
| | | cd7, cd5, id2, cd1a, cd4, cd52, zbtb16, cd1c, cd2, . . . |
| paraxial mesoderm | 30 | fgfr1, rac1, foxc1, foxc2, pax7, pax9, nkx31, pdgfra, fgf8, epha4, |
| | | pcdh8, pax1, tbx6, pax3, cdh11, axin2, gli3, gli2, gli1, . . . |
| precartilage | 35 | ccnd1, fgfr3, col9a1, col10a1, nkx32, runx3, nkx31, spp1, runx2, |
| condcnsation | | col11a1, maf, alp1, atf2, barx2, vegfa, hapln1, scin, col2a1, comp, . . . |
| lymphoid stem cell | 21 | cd7, cebpa, ikzf3, il7r, flt3, cd164, mfi2, hladra, cd44, dntt, cd34, |
| | | spi1, il4r, cd38, gata3, myb, thy1, kit, mme, . . . |
| dermomyotome | 11 | fst, nog, pax3, myf5, six1, sim1, pax7, en1, eya2, twist2, wnt11 |

The biomarker rank list generated in the first step of the pipeline is fed as input into the next step, which is analyzing the data set to allow the user to select the most appropriate biomarker panel size based on specific experimental constraints. As noted above, depending on the end user's specifications, accuracy may be sacrificed for the ability to run more samples, or higher accuracy can be specified at the cost of running fewer samples. To assist in this analysis, simulations are run utilizing the select biomarker set, and accuracy is calculated for each set. The results of the simulation are displayed in FIG. 12, which shows the accuracy rates from 12 to 384 markers. The data are provided in Table 11.

TABLE 11
Accuracy Rates for Common Sets of Markers
Used for 96- and 384-Well Plates

| Number of | % |
|---|---|
| Markers | Accuracy |
| 12 | 73 |
| 16 | 74 |
| 24 | 76 |
| 32 | 78 |
| 48 | 87 |
| 96 | 91 |
| 128 | 91 |
| 192 | 92 |
| 384 | 91 |

Table 12 shows the accuracy for common assay formats based on standard 96 and 384-well plates.

TABLE 12
How many samples can be processed for a standard 96- and
384-well plate based on the selected number of markers

| | Number of | Number of |
|---|---|---|
| Number of | Samples in | Samples in |
| Biomarkers | 96 Well Plate | 384 Well Plate |
| 12 | 8 | 32 |
| 16 | 6 | 24 |
| 24 | 4 | 16 |
| 32 | 3 | 12 |
| 48 | 2 | 8 |
| 96 | 1 | 4 |
| 128 | N/A | 3 |
| 192 | N/A | 2 |
| 384 | N/A | 1 |

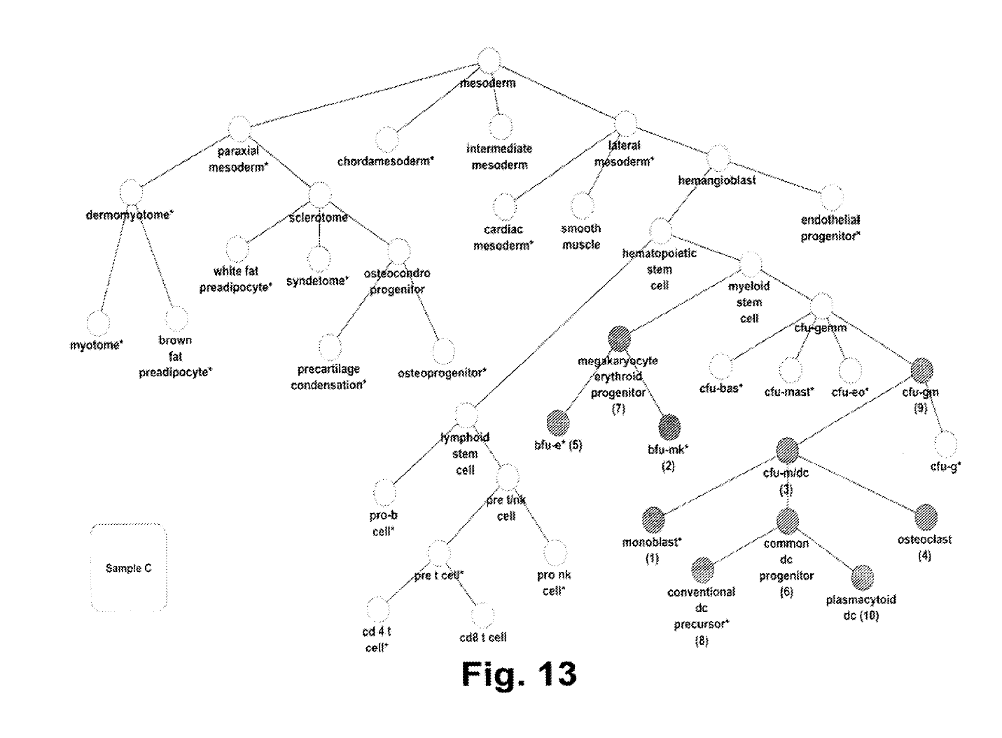

With this information, the correct biomarker panel size can be selected for individual experimental requirements and waste is avoided by considering the fact that, in this example, anything over 96 markers does not provided added accuracy. After processing the samples with the biomarker panel selected from the second step, the last step is to interpret the biomarker assay results to identify the sample. In this step, an algorithm matches the biomarker assay results against the reference data set to identify the sample, ranking possible matches from most to least. An example of the output displaying the resulting match is shown graphically in FIG. 13, where the lineage displays the same 10 cell types mapped back to a lineage map containing all of the cell types, and the matches are ranked in grey scale from dark to light indicating most (best) to least. The corresponding data, with p-values, are provided in Table 13.

TABLE 13
Top 10 matches, in ranked order from most (best) to least

| Rank | Matching Cell Types | P-Value |
|---|---|---|
| 1 | monoblast | 0.00029 |
| 2 | bfu-mk* | 9.00 × 10⁻⁰⁵ |
| 3 | cfu-m/dc | 0.000365 |
| 4 | osteoclast | 0.000365 |
| 5 | bfu-e* | 0.00016 |
| 6 | common dc progenitor | 0.000445 |
| 7 | megakaryocyte erythroid | 8.00 × 10⁻⁰⁵ |
| | progenitor | |
| 8 | conventional dc precursor* | 0.000695 |
| 9 | cfu-gm | 0.000615 |
| 10 | plasmacytoid dc | 0.00085 |

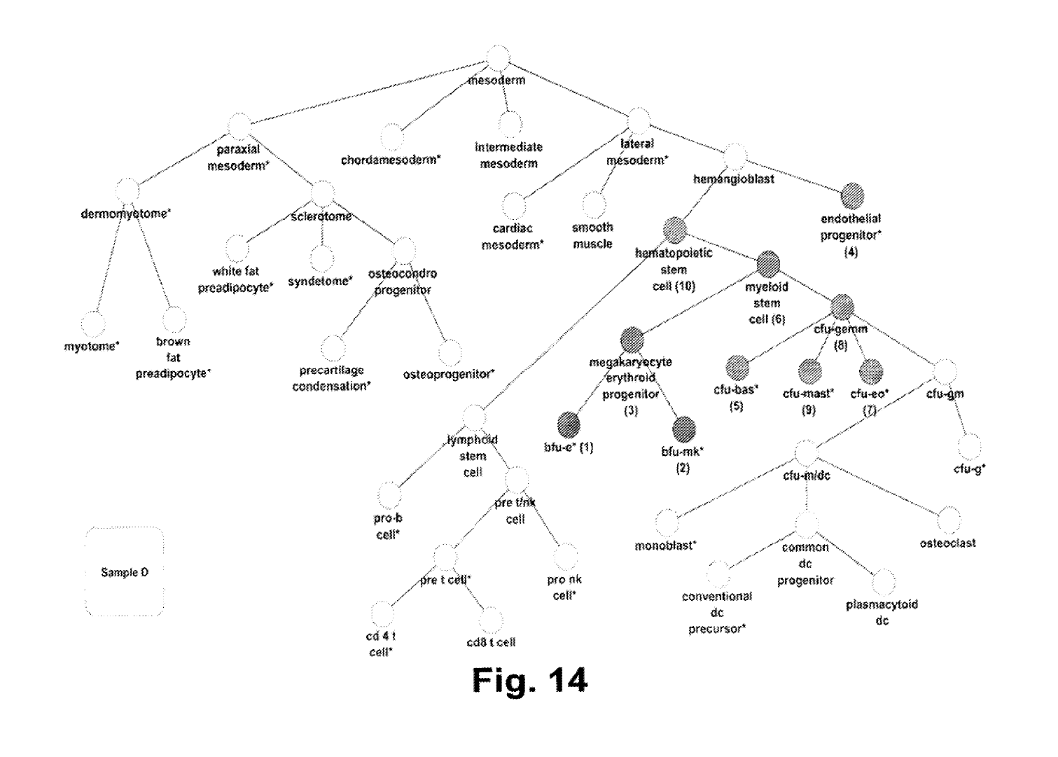

In another example of the output displaying the resulting match is shown graphically in FIG. 14, where the lineage displays the same 10 cell types mapped back to a lineage map containing all of the cell types, and the matches are ranked in grey scale from dark to light indicating most (best) to least. The corresponding data, with p-values, are provided in Table 14.

TABLE 14
Top 10 matches, in ranked order from most (best) to least

| Rank | Matching Cell Types | P-Value |
|---|---|---|
| 1 | bfu-e* | 0.001685 |
| 2 | bfu-mk* | 0.00207 |
| 3 | megakaryocyte erythroid | 0.002105 |
| | progenitor | |
| 4 | endothelial progenitor | 7.50 × 10⁻⁰⁵ |
| 5 | cfu-bas* | 0.00774 |
| 6 | myeloid stem cell | 0.002625 |
| 7 | cfu-eo* | 0.00881 |
| 8 | cfu-gemm | 0.008195 |
| 9 | cfu-mast* | 0.009095 |
| 10 | hematopoietic stem cell | 0.00073 |

In the example above, the method takes advantage of the tree structure that is inherent in a cell lineage to refine the matching algorithm. However, this is not necessary, and can be tailored to a user's reference database of unknown biological samples.

Two areas where the pipeline of the present disclosure will have particular utility are in the diagnostic sector and in the academic sector. The research and development aspect of the diagnostic sector encompasses physical use of biomedical technology to generate a marketable product or to further the knowledge of a particular science. At present, much of viral/pathogen screening, genotyping, cancer-related tests and disease testing revolve around gene expression levels. Yet conventional biomarker panel techniques employ ad hoc selection of biomarkers, and/or have no tools to interpret the results. In contrast, the pipeline of the present disclosure synthesizes the steps that permit the biomarker panel to be tailored to meet the specific requirements for accuracy, throughput, and cost for any type of end-user, can be used to discriminate among numerous different cell types or conditions (i.e., not just “X” or “not-X”), and use a rigorous matching process to interpret the results and give a numerical measure of the degree of certainty.

The pipeline of the present disclosure provides a tool to conduct research in the most high-throughput and most efficient way possible, with more accurate results than conventional methods presently being utilized. In addition, the present pipeline for biomarker panel design and interpretation offers the capability for analysis as well as a use of the product, which is a benefit not offered by techniques presently in use. For example, products for infectious diseases need to be high-throughput, widely-applicable, cost efficient, but accurate. These are all characteristics of the present pipeline, which further offers, because of its adaptability, the ability to identify many different cell types.

At present, clinical tests are used to diagnose a medical condition, and while genetic tests are becoming more common, they are difficult to develop. There are a large number of targets for clinical tests that detect cancerous cells associated with infectious and genetic diseases. The pipeline of the present disclosure permits clinical test developers to create clinical tests for these disease states. Many of the present-day therapeutic assays test for a single biomarker to determine the disease state; the present method can incorporate multiple biomarkers into similar assays for more accurate results.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the disclosure.

All of the patents and publications referred to in this disclosure are incorporated herein by reference as if fully set forth herein.

What is claimed is:

1. A method for identifying a biological sample comprising:
identifying a plurality of biomarkers that are indicia of the identity of the biological sample;
ranking the identified biomarkers from most-informative to least-informative to generate a ranked biomarker set;
selecting a biomarker panel using the ranked biomarker set and determining the size and contents of the biomarker panel;
using the biomarker panel to assay the biological sample to generate a biomarker assay output; and
comparing the biomarker assay output to reference data for the biomarkers in the biomarker panel to rank the biomarkers in the biomarker assay output from best-match to least-match as compared with the reference data to identify the biological sample.

2. The method of claim 1, further comprising:
interpreting the results of the comparison to identify the biological sample.

3. The method of claim 2, further comprising:
determining a statistical probability value that the identification of the biological sample is correct.

4. The method of claim 1, wherein selecting the biomarker panel further comprises a series of simulations that determine the size and contents of the biomarker panel providing the level of accuracy, economy, and/or throughput tailored to the specifications of an end-user.

5. The method of claim 1, wherein ranking of the plurality of biomarkers further comprises a selection algorithm that identifies a subset of biomarkers that distinguish one cell type from another in the biological sample.

6. The method of claim 1, further comprising:
displaying the results of the comparison in a table and/or in a graphical format.

7. The method of claim 2, wherein the interpretation of the results of the comparison is displayed in a table and/or graphical format.

8. A method for identifying and/or characterizing a biological sample using a pipeline comprising:
ranking a plurality of biomarkers that are indicia of the identity of the biological sample using an algorithm that generates a ranked biomarker set;
selecting a biomarker panel by a series of simulations that use the ranked biomarker set to determine a size and content of the biomarker panel that are tailored to the specifications of an end-user;
using the selected biomarker panel to assay the biological sample;
interpreting the results of the assay from best-match to least-match as compared with reference data to identify and/or characterize the biological sample.

9. A method for selecting a biomarker panel for characterization and/or identification of a biological sample by a pipeline comprising:
selecting a plurality of biomarkers that characterize and/or identify the biological sample;
ranking the biomarkers by a sequence of steps from most-informative to least-informative to generate a ranked biomarker set; and
selecting a biomarker panel using the ranked biomarker set by a series of simulations that determine the size and contents of the biomarker panel.

10. The method of claim 9, wherein selecting of the biomarker panel is based on a level of accuracy, economy, and/or throughput that are tailored to the specifications of an end-user.

11. A method for generating a biomarker assay output for characterizing or identifying a biological sample by a pipeline comprising:
selecting a plurality of biomarkers that characterize or identify the biological sample;
ranking the biomarkers from most-informative to least-informative by a sequence of steps that generate a ranked biomarker set for characterization or identification of the biological sample;
selecting a biomarker panel by a series of simulations using the ranked biomarker set that determine the size and contents of the biomarker panel; and
assaying the biological sample using the selected biomarker panel to generate a biomarker assay output.

12. The method of claim 11, further comprising:
interpreting the biomarker assay output.

13. The method of claim 12, further comprising:
displaying the biomarker assay output.

14. A method for generating a biomarker results set for characterizing or identifying a biological sample by a pipeline comprising:
selecting a plurality of biomarkers that correspond to the biological sample;
ranking the biomarkers from most-informative to least-informative by a sequence of steps that generate a ranked biomarker set for characterization or identification of the biological sample;
using the ranked biomarker set in a series of simulations to select the size and contents of a biomarker panel that correspond to the specifications of an end-user for accuracy, economy and/or throughput;
using the selected biomarker panel to assay the biological sample to generate a biomarker assay output; and
comparing the biomarker assay output to reference data for the biomarkers in the biomarker panel to generate a biomarker results set.

15. The method of claim 14, wherein the biomarker results set ranks the biomarkers in the biomarker assay output from best-match to least-match as compared with the reference data.

16. The method of claim 15, further comprising:
interpreting the biomarker results set.

17. The method of claim 15, further comprising:
displaying the biomarker results set.

18. A method for selecting a biomarker panel for characterization or identification of a biological sample by a pipeline comprising:
selecting a plurality of biomarkers that characterize or identify the biological sample;
ranking the biomarkers, by a sequence of steps, from most-informative to least-informative to generate a ranked biomarker set; and
selecting a biomarker panel using the ranked biomarker set by a series of simulations that determine the size and contents of the biomarker panel corresponding to the specifications of an end-user.
